(19) United States
(12) Patent Application Publication
(10) Pub. No.: US 2010/0218959 A1
(43) Pub. Date: Sep. 2, 2010

(54) Method and device for suppression of fire by local flooding with ultra-fine water mist

(75) Inventors: Kayyani C. Adiga, Macon, GA (US); Rajani Adiga, Macon, GA (US); Robert F. Hatcher, Macon, GA (US)

Correspondence Address: BRIAN D. BELLAMY, P.O. BOX 1997, THOMASVILLE, GA, 31799-1997, US

(73) Assignee: Nanomist Systems, LLC, Macon, GA (US)

(21) Appl. No.: 12/547,229

(22) Filed: Aug. 25, 2009

Related U.S. Application Data
(63) Continuation of application No. 11/307,773, filed on Feb. 21, 2006, now abandoned.
Application No. 11/307,773 is a continuation-in-part of application No. 11/306,244, filed on Dec. 20, 2005.
Application No. 11/306,244 is a continuation of application No. 10/247,147, filed on Sep. 19, 2002, now Pat. No. 7,090,028.
(60) Provisional application No. 60/654,619, filed on Feb. 18, 2005.
(60) Provisional application No. 60/323,399, filed on Sep. 19, 2001.

(51) Int. Cl. A62C 3/06; A62C 31/00

(52) U.S. Cl. 169/45; 169/65; 169/5

(57) ABSTRACT

A method and device for suppression of fires related to heating appliances, vent hoods and work benches through deployment of very fine mist droplets, preferably less 100 micron diameter, into the firebase. A low momentum, high mist loading fine mist stream is introduced about the firebase. Mist is discharged to the firebase through diffusers or swirl channels so that the mist surrounding the firebase will be entrained into the firebase to secure and suppress the fire. After the fire is suppressed, the fine mist is further discharged to the hot oil surface for cooling.

### PRIORITY CLAIM

This application is a continuation of U.S. Ser. No. 11/307,773 filed Feb. 21, 2006 and entitled “A method and device for suppression of fire by local flooding with ultra-fine water mist,” and the priority of U.S. Provisional Application No. 60/654,619 filed Feb. 18, 2005 is claimed.

This application is a continuation in part of U.S. Ser. No. 11/306,244 filed Dec. 20, 2005 and entitled “Fire suppression using water mist with ultrafine size droplets,” which was a continuation of U.S. Ser. No. 10/247,147 filed Sep. 19, 2002 (US Pub No 2003/0051886) now U.S. Pat. No. 7,090,028 and that claimed benefit of U.S. Provisional Application No. of 60/323,399 filed Sep. 19, 2001.

### BACKGROUND OF THE INVENTION

### Field of Invention

The present invention relates to controlling and suppressing fires occurring in cooking or other hot sites. And, more particularly, the invention relates to a method and device for fire suppression in sites such as deep fat fryers and cooking ranges by locally flooding the site with a fine water mist and provides control of the mist discharge, whereby the mist is introduced into the firebase.

A typical fuel load in commercial deep fryers is on the order of 80-100 pounds of cooking grease. Other small localized sites using oil, grease or fuel to heat or cook are also applicable. When such grease or fuel overheats, the enormous amount of energy stored should be absorbed or dissipated in order avoid ignition. Alternatively, once a fuel load overheats and ignites, the resulting fire should be extinguished quickly, and the surface temperature of the fuel should be reduced substantially below the auto-ignition temperature. The auto-ignition temperature of typical cooking oils range from 360-370 degrees Celsius (680-700° F.). Burning oil surface temperature may reach in excess of 404° C. (760° F.). Further complicating the problem of post suppression re-ignition, the burning of the oil changes its properties and further reduces the auto ignition temperature to a point lower that its initial value. The extreme temperatures of burning fuel and propensity for re-ignition make cooking oil fires particularly dangerous and difficult to permanently extinguish. While specific examples are not given, it is also foreseen that other local defined sites used for cooking or heating may be particularly dangerous and difficult to suppress in the case of ignition and fire.

The prior art method for suppression of fires in such locations as deep fat fryers includes the discharge of chemicals into the fire from above. The fire is extinguished by formation of a foam blanket barrier on top of the fuel, preventing further oxygen from reaching the fuel surface. The chemical barrier will ultimately prevent re-flash of the fire. A shortcoming of chemical discharge method is a slow cooling rate. The rate of cooling of the fuel is limited by the insulating effect of the chemical barrier blanket deposited on the fuel surface. By experiments, it is known that the cooking oil temperature has to be cooled by about 33° C. (60° F.) below the initial auto-ignition temperature of the oil to avoid the possibility of re-flash. Since the chemical foam blanket hampers cooling, further methods involve the use of a large droplet 200-250 micron spray of water after the application of the foam blanket to cool the oil and keep the oil from igniting again. This creates extensive cleanup time and fire hazard. Moreover, there is a great impetus to replace chemical-based fire suppression systems because of environmental concerns and expense due to down time.

More recent technology involves direct injection of large droplet water spray from above a fire location to suppress fires in deep-fat fryers. This method uses high momentum jets to cause the large water droplets to penetrate the fire and finally cool the fuel surface. The spray method of this technology utilizes a large quantity of water within a very short time interval of 1-2 minutes. During the water discharge, hot boiling oil can splash causing a dangerous situation for nearby personnel. Furthermore, the oil that escapes can self-ignite on the floor or other unprotected surfaces of the appliance.

The critical challenges in fire protection of a heating or cooking site include the need to rapidly extinguish fires without collateral damage and reducing the need for extensive clean up. Preferably, downtime will be reduced and the use of chemical agents can be eliminated.

A new technology to put out such kitchen fires and other heating site fires using fine water mist is desirable. Water is inexpensive and does not cause environmental toxicity problems.

### SUMMARY OF THE INVENTION

Water can now be atomized to a very small size, such as below 20-30 micron in diameter. The vaporization rate of water atomized to such as small scale has been found to be very high. In addition, the surface area of such fine scale water droplets is large relative to the overall mass of the droplets. The large surface area of the fine mist absorbs energy much more rapidly from a fire than a similar amount of large size water mist droplets. The invention provides for suppression of heat site fires using fine water mist, such as less than 20-30 micron diameter. If properly introduced to the firebase, the fine water mist will quickly extract heat from the firebase with a very small quantity of such fine scale atomized water as compared with larger scale mists. The invention provides for introduction of the fine mist in such a way that it is entrained at the firebase by specific flow patterns or properties, rather than forced by relatively high momentum through the flames from above the fire and into contact with the fuel surface. The previous methods of high momentum water mist fire suppression provide top injection by force as opposed to introduction of the mist into the fire field by low momentum and entrainment into the firebase. In top injection, a majority of water is lost by vaporization as it transverses the fire region without reaching the fuel surface. Self-entrainment of a mist cloud into the firebase ensures securing of the fire and complete use of the mist in extracting heat at the firebase where it is most desired. The present method not only puts out a heat site fire, but also cools the surface of the fuel source and prevents re-flash or reigniting of the fire.

For example, fires in deep fat fryers occur when the oil temperature exceeds its auto-ignition temperature. If a cloud of mist manipulated having characteristics and disposition as defined by the invention is made present about the firebase, the buoyancy driven upward flow of the fire pulls the mist into the firebase. The mist is present along with or in place of the ambient air. The invention provides for the presence of the mist in such fine scale, location and momentum to suppress the heat site fire by such entrainment of the mist.

With respect to application to deep fat fryers, a flow channel makes a mist of extremely fine droplet scale readily available for entrainment in deep fat fryers by disposition at low momentum at the firebase. The flow channel can be fixed or directed to the fryer oil surface on the deep fat fryer, or a cooking range, so that the fine water mist can be delivered to the firebase for effective entrainment. Re-ignition of the hot oil before it cools below its minimal re-flash temperature is prevented by the fine water mist during the cooling process. While the hot oil of a deep fat fryer fire suppressed by use of the device herein may cool for 20-30 minutes, the ultra fine water mist, particularly below 20-30 micron diameter does not cause wetting or disposition of the mist on the hot oil surface. Therefore, the technology prevents collateral damage by the water and eliminates hot oil splashing from impact of the water on the hot oil surface. The device causes the deep fat fryer fire to be extinguished using a minimum amount of water.

As one objective of the invention, a cloud of such fine mist can be delivered to fire base by alternatives to the flow channel to accomplish disposition to the surrounding area of the firebase for successful entrainment. A diffuser or delivery outlet duct may be directed to the top surface of oil by fixing the device to the rim of the appliance. It is further recognized that a flow channel may be fixed to the rim of the appliance about the top surface area thereof. Thus, the fine mist can be delivered from above the hot oil surface by directing the fire mist about the firebase, rather than injecting a larger scale mist through the fire itself.

Another objective of the present invention is to avoid using chemicals for suppression of fires in deep fat fryer oils to avoid toxicity, corrosiveness, potential electrical conduction and post-fire cleaning issues.

Yet another objective of the present invention is to introduce a fine mist mixture with air of appropriately high water content to a heat site of an appliance so as to quickly and completely extinguish an oil fire.

A further objective is to deploy an extremely fine mist preemptively to control the surface temperature of oil within an appliance so that the oil will not exceed auto-ignition temperature.

A further objective is to deploy an extremely fine mist to control surface temperature of oil without causing collateral damage by cooling the surface temperature thereof without injection into the surface of the fuel.

Another objective is to deploy fine mist for cooling and preventing hot oil re-igniting or re-flashing after an oil fire has been extinguished. The initial fire may be suppressed by the current methods of the invention or by another suitable method such as one of the current wet chemical systems used in restaurant protection systems. The fine mist application of this invention will not wet the fryer surface or nearby area since it vaporizes quickly, while preventing re-igniting. In addition, since the current system does not use stored pressure, but rather ultrasonic atomization, the mist can be discharged for a longer period until the oil temperature is far below its auto ignition temperature.

Another objective is to apply the techniques of the current invention to other appliances with heat sites, such as to protect a cooking range.

Another objective is to direct a fine mist flow with respect to the surrounding area of a firebase, as such fire may occur inside of a cooking area hood, so as to prevent or suppress fire within the hood.

Based upon the disclosure of this invention and the claims herein, these and other objects of the invention will be apparent to those skilled in the art as to application to a variety of heat sites related to appliances and devices used for heating and cooking. Still other various objects will be apparent in particular with respect to the physical mechanism for disposition of mist in the area of a firebase with respect to an appliance heat site without forcefully directing flow of mist comprising large size droplets into a flame. It is further recognized that the physical structure of the channel, diffuser and discharge outlets discussed herein may be modified within the scope of the claimed invention.

### DESCRIPTION OF THE DRAWINGS

FIG. 1 is a perspective view of an embodiment of a device for practice of the invention having a flow channel for disposition of fine mist.

FIG. 2 is a perspective view of an embodiment of a device having a second variation of a flow channel for disposition of fine mist.

FIG. 3a is a perspective view of a representation of fine mist surrounding a firebase in an appliance.

FIG. 3b is a perspective view of a representation of fine mist greatly reducing a fire flame through entrainment into the firebase.

FIG. 3c is a perspective view of a representation of fine mist completely suppressing a fire through entrainment into the firebase.

FIG. 4 is a perspective view of an embodiment of a device for practice of the invention having a mist diffuser for disposition of fine mist and multiple fine mist generators.

FIG. 5 is a perspective view of an embodiment of a device for practice of the invention having a mist diffuser for disposition of fine mist and a single fine mist generator.

FIG. 6 is a perspective view of an embodiment of a device for practice of the invention having a mist discharge for disposition of fine mist from above the firebase.

FIG. 7 is perspective view of a room with cooking appliances arranged with a mist diffuser and mist generating units.

FIG. 8 is a graph of fire and oil temperature histories with respect to a deep fat fryer using fine mist for fire suppression.

### DESCRIPTION OF THE INVENTION

In a first embodiment of the present invention very fine mist droplets of less than 100 micron diameter is deployed into a deep fat fryer for entrainment of the mist into the firebase. The fine mist may be refined to less than 50 micron diameter droplets, and even further, may be refined to less than 30-20 micron diameter droplets. A low momentum fine mist stream with a high water loading (up to 20-40%) of the mist will be introduced into the firebase via a swirling flow generated along the fryer rim. A specially designed channel inserted around the fryer rim can be used to create the required flow field. In alternative embodiments, the necessary flow about the firebase may be disposed to a heating or cooking appliance, in this case a deep fat fryer, by diffusion or low momentum discharge. Only a fraction of the water that is used in top injection spray methods is used by the present invention because of mist droplet size, momentum, and method of suppression by entrainment.

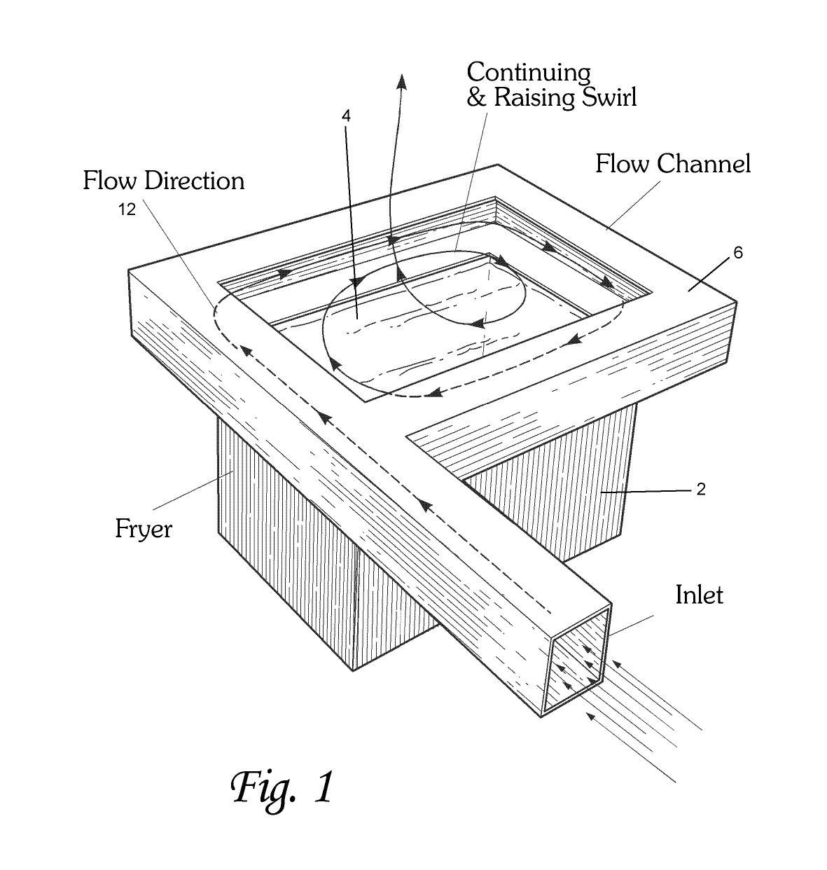

An example deep fat fryer 2 as an example of a localized heat site using a hot fuel source 4 is shown in FIG. 1. While the lower part is a typical basic design of a regular deep fat fryer, the top fixture depicts a potential design to guide the fine scale mist into the firebase in the form of a swirling flow around the firebase. Thus, a suitable guide 6 should be provided as means for distributing the fine mist about the hot fuel source.

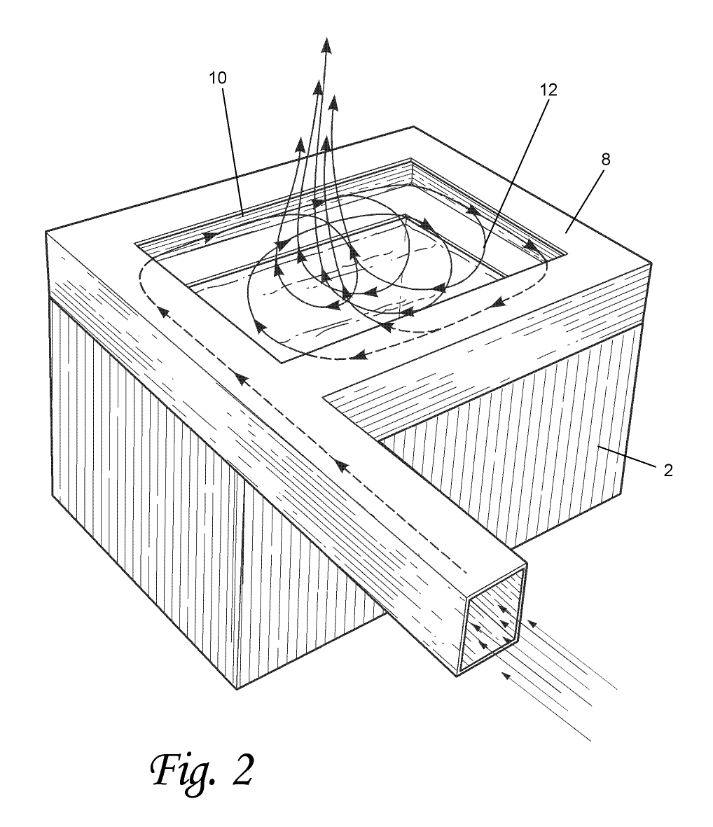

FIG. 2 shows the top flow channel fixture 8 added to an existing deep fat fryer 2 with the channel 10 incorporated into the rim. This channel can appear discrete and unnoticeable until the mist is deployed, addressing concerns for functionality and appearance of the fixture.

FIGS. 1 and 2 also illustrate the direction of mist flow 12 inside the channel. Experiments have demonstrated that the fine mist is entrained from the surrounding mist flow into a pool fire as created by ignition of grease in deep fat fryer.

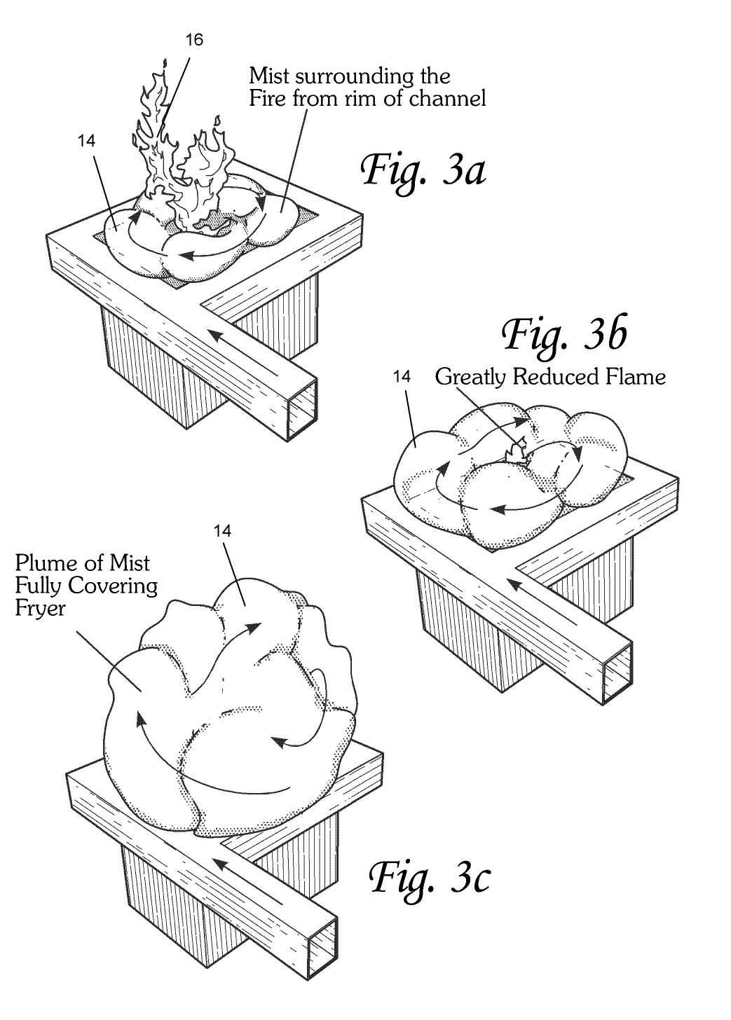

FIGS. 3a-3c show how the ultra fine mist 14 disposed about the firebase within the heat site surrounds the fire 16. The mist also surrounds the hot fuel or oil surface 4. The mist is swirled around the oil or grease fire via a flow pattern created at the rim of the fryer as shown in FIG. 3a. The mist quickly surrounds the fire and entrains itself inside the fire plume as shown in FIG. 3b. As the fire entrains the mist, the fire will breaks in two and the top part will detach itself and leave the base. Within seconds, the fire goes out as the plume of mist completely engulfs the fire from self-entrainment of the mist by the fire and complete suppression of the fire.

The fire goes out quickly leaving a mass of fine mist, which will further cool the oil or other hot fuel. The fine mist discharge can be continued for a desired length of time after extinguishment so that the hot oil will not re-ignite. Because of the extremely small size of the fine mist droplets with a large surface area, the cooling of the heat site surface is efficient and takes only a small amount of water. Further, the fine mist is not injected toward the heat site surface and does not cause splatter or wetting.

While the fine mist may be introduced using a low-momentum swirling flow, the mist can also be discharged onto the fuel surface using a diffuser 18 either attached to a fryer rim or included on a side of the heat site, such as in the backside dashboard where the flue vent may be located. The side mounted diffuser may be arranged and fixed all-around the rim or surface of the heat site, or only on one side. The diffuser illustrated includes a horizontal member for spreading the mist and a discharge area 20 on the horizontal member for directing the mist toward the hot surface 24 of the heat site fuel as shown by the arrows 22. Several additional diffusers may be applied lengthwise for a larger appliance.

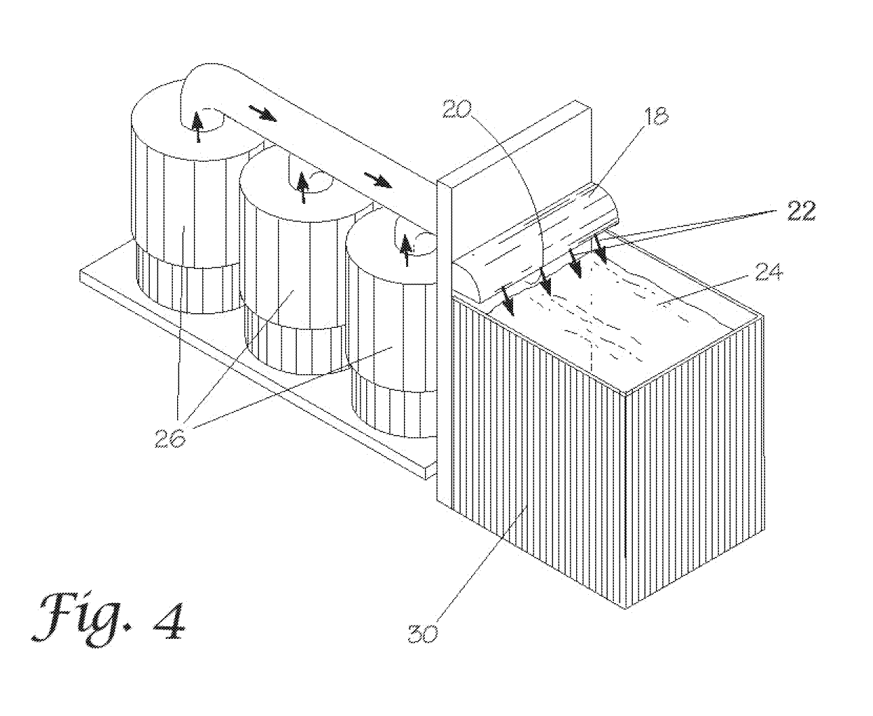

FIG. 4 shows several fine mist generators 26 delivering mist by a delivery tube 28 to a diffuser 18 located on the backside of a deep fat fryer 30. The diffuser 18 disposes the mist about a portion of the oil surface 24, where a firebase would exist upon ignition of a fire. A fire will entrain the fine mist, and the mist will completely surround the firebase and quickly begin to diminish the fire without the need to inject the mist into the fire flame.

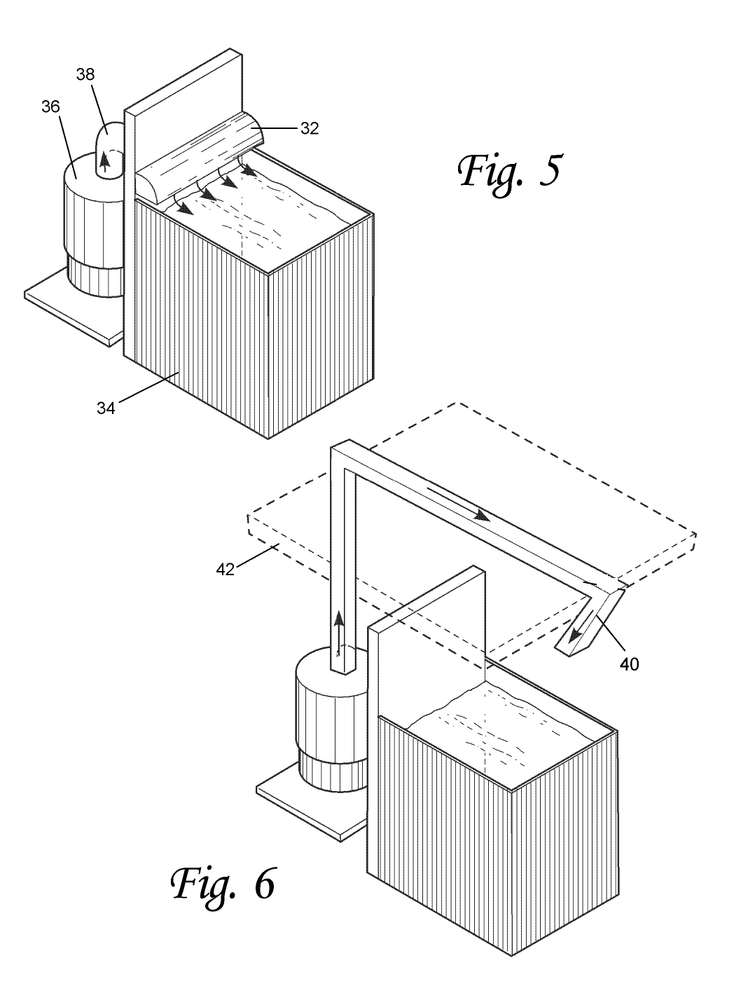

A variety of mist generator configurations and delivery connections may operate in combination with the mist delivery mechanism, such as the diffuser. FIG. 5 illustrates a mist diffuser 32 located on a side of a deep fat fryer 34 and a single mist generating unit 36 stored separately and out of view connected by a delivery tube 38 to the mist diffuser. The mist diffuser releases the mist so as to direct the fine mist about the firebase.

FIG. 6 shows a mist discharge from the above, such as from the hood over a stove or fryer. Locating the discharge above the heat site is helpful in providing a fixed system; in particular the discharge outlet 40 may be located in an existing hood 42. This configuration does not need a special diffuser to be installed, but may be somewhat slower in fire suppression than using a swirled disposition or diffuser. By providing a specific momentum and fine mist size, the mist will be entrained by the fire into the fire base, with a delay caused by the initial discharge location of the fine mist being initially farther from the firebase. Nonetheless, the discharge from above, with momentum and mist quality engineered for self-entrainment, suppresses heat site fires more successfully with advantages over direct injection large-size mist systems or chemical systems.

The fine mist deployed by the methods discussed not only suppresses fire in deep fat fryers and the like using a chemical free fine water mist system but also cools and secures the hot oil surface to prevent ignition or re-ignition. Temperature may be monitored in the surface of the heat fuel and the fine water mist deployed in accordance with measured temperature to prevent ignition. While cooling, since the fine mist vaporizes quickly, the fine mist does not wet the area, unlike an injection based water spray system. The fine mist can be discharged for as much as 20 minutes or more until the oil cools far below the auto-ignition temperature. Furthermore, the vaporizing fine water mist produces steam that blankets the hot oil surface along with the fine mist aiding the process of preventing of reflash while the oil cools. This effect improves the mists ability to secure the oil surface from reflash in a way that is safe for nearby personnel.

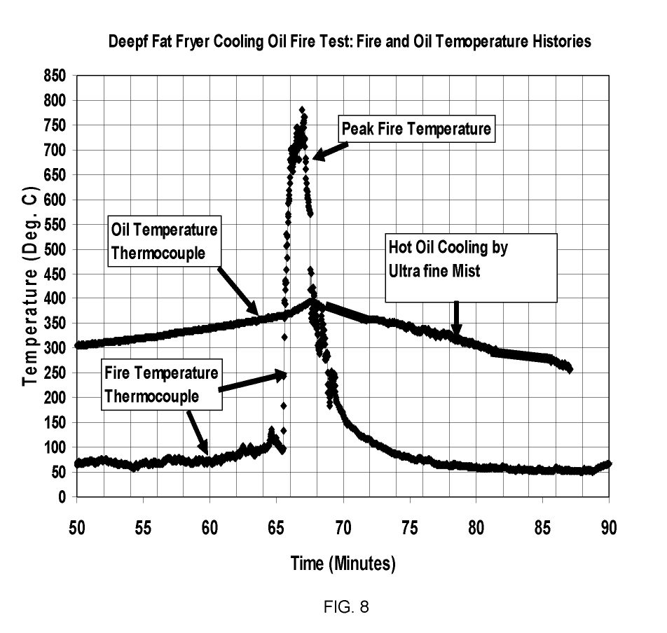

An experimental thermal profile of oil is shown in FIG. 8 related to cooling by fine mist. With a thermocouple inserted one inch below the oil surface, the oil temperature and fire temperature is measured before ignition, during ignition and during cooling by fine mist to create a temperature history before and after suppression by fine mist. The fryer contains 65-85 lb oil and reflash is prevented by the fine mist cooling. The hot oil gradually cools by application of the fine mist as shown by the graph. After reaching peak fire temperature, the fire is quickly suppressed by the application of the fine mist to the firebase.

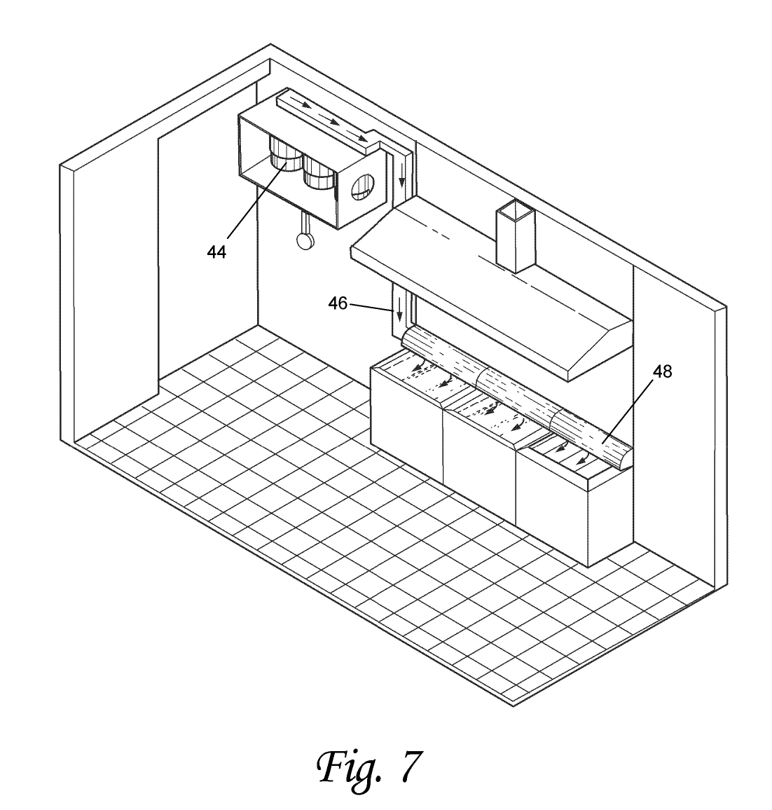

The fine mist device and method may be applied in a commercial kitchen restaurant as shown in FIG. 7 having mist generating units 44, conveyance tube 46, and discharge members 48. As compared with a commercial high pressure water mist injection system, the fine mist system only uses a fraction of the amount of water. For instance, in one example an ultra-fine mist entrainment system used below 20 micron diameter droplets at 0.25 m/s velocity and only used 200 ml of water. Whereas, a high pressure water mist injection system used 250 micron diameter droplets at 25 m/s velocity and used several liters of water. Thus, a simple analysis and comparison of the present system's fine mist discharge and entrainment system with the top injection of high-pressure mist for suppression shows considerably lower water consumption using an ultra-fine mist.

A high momentum spray of high-pressure mist systems cools the fire after a considerable penetration from the top. The discharge of the injection based system requires high momentum to penetrate into the fire. The droplets of the injection based system vaporize relatively far from the firebase causing low efficiency cooling. Whereas in contrast, base injection of fine mist positions the fine mist around the critical inflow region of the firebase, avoiding excess water vaporization during the fire suppression cycle.

In another embodiment, another suppression method such as wet chemical may be used to put out a heat site fire. After the fire has been knocked out, fine mist discharge may be used to cool the site. This hybrid approach avoids the use of large amounts of chemical to form a foam layer and blanket the oxygen. In order to form such a chemical blanket, a significant amount of chemical has to be injected onto the surface. This excessive use of chemical can be eliminated to reduce cleanup and downtime. In addition, in some prior art, high-pressure water spray is injected quickly with a high momentum in order to cool the oil. With the prior water injection method, a considerable amount of the water application is required, since the application time is only 1-2 minutes. Whereas, fine mist in accordance with the invention vaporizes quickly and can be continuously discharged for a long period of time for cooling without any collateral damage.

As a further embodiment of the invention, ultra-fine mist is preemptively discharged with respect to the oil surface of a deep fat fryer when the surface temperatures reach a predetermined temperature based on the auto-ignition temperature of cooking oil. A sensor output drives the mist discharge sequence. An ultra-fine mist preemptively cools and vaporizes quickly with no adverse effect on the deep fryer functionality. Unlike regular water mist that causes wetting and splattering, the fine mist system herein provides a safer and fire-free environment.

A further embodiment applies to fires in clean rooms, such as electronics/semiconductor assembly rooms and wet-bench areas or chemical mixing operations involving flammable materials in pharmaceutical industries and the like. In these applications, an ultra-fine water mist is discharged through a diffusion or swirl-creating fixture on the sides of the wet-bench. As in FIGS. 3a through 3b, the mist will swirl and entrain itself into the fire on the wet-bench similar to how the mist is entrained at alternative heat sites, such as a deep fat fryer. The mist can be introduced simply using diffusers with no swirl at all, or with a swirl provider securing the fire. However, it is not necessary have a swirl channel. Instead, mist can be introduced at selected locations using a diffuser. The mist provides such a dry environment of fire suppression that it will not cause damage to the surrounding electronics. Prior art provides a CO2 based fire suppression system that is potentially harmful to people working in the area and causes significant air contamination. Also in prior art systems, water spray is used to put out fires. The collateral damage is huge while using such spray systems discharging large amounts of water. Ultra-fine water mist as provided in the present embodiment will extinguish a fire quickly with a minimum amount of water and therefore reduces the air borne contaminant which is very important in clean rooms, while not causing collateral damage to clean room contents and materials. This is also a good fire suppression system for heat sites such as wet chemical bench areas in pharmaceutical industries and other chemical work benches.

It will be obvious to those skilled in the art that substitutions and equivalents will exist for the elements of embodiments illustrated above. The true scope and definition of the invention, therefore, is set forth in the following claims.

What is claimed is:

1. A method for prevention and suppression of fire comprising the steps of: (a) generating a mist comprising water of fine droplet size; (b) providing a flow of the mist at low momentum without generating a high-momentum spray of water; (c) discharging the mist about a hot fuel surface of a heat site; and (d) controlling momentum, water loading in the mist, droplet size and location of discharge of mist to cool the hot fuel surface without impingement of the high-momentum spray into the hot fuel surface.

2. A method for prevention and suppression of fire as in claim 1 including the additional step of entraining the mist into a firebase without directing the mist into a flame and without penetration by forceful injection of the mist.

3. A method for prevention and suppression of fire as in claim 1 in which the hot fuel surface of the heat site is continuously maintained at a temperature below an auto-ignition temperature by cooling by the discharging of the mist.

4. A method for prevention and suppression of fire as in claim 2 in which the step of discharging the mist about the hot fuel surface of the heat site includes discharging the mist by creating a swirl flow about the hot fuel surface to effectively position the mist for entrainment into the firebase.

5. A method for prevention and suppression of fire as in claim 1 in which the step of discharging the mist about the hot fuel surface of the heat site includes discharging the mist through a channel about the hot fuel surface so as to create a swirl flow about the hot fuel surface.

6. A method for prevention and suppression of fire as in claim 4 in which the heat site includes a rim about an upper member and the channel is situated about the rim.

7. A method of prevention and suppression of fire as in claim 1 in which the step of discharging the mist includes providing a diffuser mechanism for releasing the mist and expanding the flow of the mist about the hot fuel surface and providing the mist with an appropriate entrainment momentum and flow field.

8. A method for prevention and suppression of fire as in claim 1 in which the step of discharging the mist includes providing a discharge member above the heat site for releasing the mist about the hot fuel surface and gradually surrounding the surface for cooling or fire suppression without directly injecting the mist into a flame.

9. A method for prevention and suppression of fire as in claim 1 in which the fine mist comprises droplets less than 100 micron in diameter.

10. A method for prevention and suppression of fire as in claim 1 in which the fine mist comprises droplets less than 50 micron in diameter.

11. A method for prevention and suppression of fire as in claim 1 in which the fine mist comprises droplets less than 30 micron in diameter.

12. A method for prevention and suppression of fire as in claim 1 in which the heat site includes a deep fat fryer.

13. A method for prevention and suppression of fire as in claim 1 in which the heat site includes a cooking range.

14. A method for prevention and suppression of fire as in claim 1 in which the heat site includes a vent hood or range hood.

15. A method for prevention and suppression of fire as in claim 1 in which the heat site is a wet-bench involving flammable materials.

16. A method for prevention and suppression of fire as in claim 1 in which the heat site is an electronics assembly site involving flammable materials.

17. A device for prevention and suppression of fire including a mist generator, a conduit for moving a flow of mist from the mist generator, a discharge member situated in close relationship to a hot fuel surface of a heat site for disposition of a flow of mist about the hot fuel surface.

18. A device for prevention and suppression of fire as in claim 17 in which the discharge member include a channel situated about a rim on the heat site.

19. A device for prevention and suppression of fire as in claim 18 in which the channel is round or rectangular in geometry.

20. A device for prevention and suppression of fire as in claim 17 in which the discharge member is situated in a hood above the heat site.

21. A device for prevention and suppression of fire as in claim 17 in which the discharge member is a diffuser situated along an edge of the heat fuel surface on top of the heat site.

22. A method for preventing hot oil surface fires comprising the steps of (a) generating a mist comprising water of fine droplet size; (b) providing a flow of the mist at low momentum without generating a high-momentum spray of water; (c) discharging the mist about the hot oil surface of a heat site while the hot oil surface temperature is below an auto-ignition temperature of the hot oil surface; and (d) controlling momentum, water loading in the mist, droplet size and location of discharge of mist to cool the hot oil surface without impingement of the high-momentum spray into the hot oil surface.

23. A method for preventing hot oil surface fires as in claim 22 including the additional step of monitoring the hot oil surface temperature and correlating the step of discharging the mist about the hot oil surface with the temperature of the hot oil surface so as to maintain the temperature of the hot oil surface below the auto-ignition temperature.

24. A method for cooling of a heat site hot fuel surface and suppression of a heat site fire including the steps of: (a) generating a fine mist comprising droplets having a droplet scale diameter of less than 100 micron; (b) providing a flow of the mist at low momentum and having a specific water loading in the mist; (c) discharging the mist about the hot fuel surface of the heat site; (d) controlling the momentum, the droplet scale, the specific water loading in the mist and location of discharge of the mist to cool the hot fuel surface without impingement of the mist into the hot fuel surface; (e) providing an initial high throughput of the mist of more than 1 liter per minute until suppression of a heat site fire; and (f) after the fire is extinguished, providing a reduced throughput of mist of less than 1 liter per minute for cooling the hot fuel surface.

25. A method for cooling of a heat site hot fuel surface and suppression of a heat site fire including the steps of: (a) generating a fine mist comprising droplets having a droplet scale diameter of less than 100 micron; (b) providing a flow of the mist at low momentum and having a specific water loading in the mist; (c) discharging the mist about the hot fuel surface of the heat site; (d) controlling the momentum, the droplet scale, the specific water loading in the mist and location of discharge of the mist to cool the hot fuel surface without impingement of the mist into the hot fuel surface; (e) providing an initial suppression of the heat site fire by a chemical agent; and (f) after the fire is extinguished, providing a reduced throughput of mist of less than 1 liter per minute for continued cooling the hot fuel surface.
